(19) United States
(12) Patent Application Publication
(10) Pub. No.: US 2006/0083674 A1
(43) Pub. Date: Apr. 20, 2006

(54) Method for forming catalyst metal particles for production of single-walled carbon nanotube

(76) Inventors: Shigeo Maruyama, Tokyo (JP); Yoichi Murakami, Tokyo (JP); Tatsuya Okubo, Tokyo (JP); Shigehrio Yamakita, Miyagi (JP)

Correspondence Address: BIRCH STEWART KOLASCH & BIRCH, PO BOX 747, FALLS CHURCH, VA, 22040-0747, US

(21) Appl. No.: 10/545,298

(22) PCT Filed: Feb. 16, 2004
(86) PCT No.: PCT/JP04/01620

§ 371 Date: Aug. 11, 2005

(30) Foreign Application Priority Data
Feb. 14, 2003 (JP) 2003-036928
Feb. 26, 2003 (JP) 2003-049552

(51) Int. Cl. D01F 9/12; B01J 23/00; B05D 3/04; B05D 3/02

(52) U.S. Cl. 423/447.3; 502/325; 427/372.2; 427/301

(57) ABSTRACT

Provided is a process for forming catalyst metal fine particles for synthesizing a single-walled carbon nanotube by a CCVD process on a substrate, wherein a solution is prepared by dispersing or dissolving a catalyst metal salt of an organic compound or an inorganic compound in a solvent; the solution is coated on the substrate and dried; then, the substrate is heated in an oxidative atmosphere to thereby remove the solvent component remaining on the substrate by oxidative decomposition, and fine particles of an oxide of the catalyst metal are formed on the substrate; and then, the oxide of the catalyst metal is reduced in an atmosphere of an inert gas or a gas having reducing action to fix the catalyst metal fine particles on the substrate.

### TECHNICAL FIELD

The present invention relates to a process for forming on a substrate, metal fine particles which are used as a catalyst for producing a single-walled carbon nanotube, specifically to a process for forming catalyst metal fine particles of 10 nm or less in diameter on a substrate.

### BACKGROUND ART

A carbon nanotube (hereinafter referred to as CNT) is a carbon cluster comprising a cylindrically wound graphene sheet and having a cross-sectional diameter of 100 nm or less. It is reported in many cases that particularly a single-walled carbon nanotube (hereinafter referred to as SWNT) comprising one layer of a graphene sheet is useful as a nano-structural material because of specific electrical and chemical characteristics thereof.

An arc discharge process, a laser ablation process, a high frequency plasma process and a thermal decomposition process are known as a production process for SWNT. Further, reported are various measures for the kind of catalysts used in the above production processes and a method for supporting them.

A process in which used are hydrocarbon as a carbon source and a mixed gas of helium and hydrogen as a carrier gas and in which a carbon electrode and a mixed electrode of metal and carbon are used is disclosed as a production process for SWNT by arc discharge in Japanese Patent Application Laid-Open No. 197325/1995.

Researchers of Rice University disclose a process in which carbon is vaporized by a conventional laser pulse method of Smalley et al. and metal catalyst fine particles of cobalt and the like are floated in the vicinity of a laser focus to produce carbon clusters staying in a free state and in which the clusters are annealed at 1000 to 1400° C. and 100 to 800 Torr (Japanese translation of PCT international publication for patent application No. 520615/2001).

A process in which a hydrocarbon gas and a powdery metal catalyst are blown into a high frequency plasma in a rare gas atmosphere is disclosed as a high frequency plasma process in a Japanese Patent No. 2737736 gazette.

Disclosed in Japanese Patent Application Laid-Open No. 011917/1999 is a process in which a fine particle metal catalyst of cobalt, iron and the like is supported on an oxide film on anode and in which a hydrocarbon is reacted in a low pressure and low ionized gas plasma generated by micro wave glow discharge.

In contrast with the above processes, when using a thermal decomposition process, that is, a CCVD (catalytic chemical vapor deposition) process, metal fine particles have to be supported on a substrate. When producing SWNT, a diameter of a metal fine particle is an important factor for determining the physical properties of SWNT. However, it used to be difficult to allow metal fine particles of 10 nm or less in diameter to be present on a substrate under a high temperature condition in producing SWNT while preventing them from coagulating or coalescing by thermal oscillation in chemical vapor deposition (CVD).

Li et al. report a method in which in order to dispose iron in a fine particle state which is a catalyst on a silicon substrate, iron is stored in the inside of iron-storing protein called ferritin and then this protein is dispersed and disposed on the silicon substrate and in which the substrate is heated in an oxidative atmosphere to decompose a protein part, whereby only iron stored in the inside thereof is disposed on the silicon substrate (Yiming Li et al., “Growth of Single-Walled Carbon Nanotubes from Discrete Catalytic Nanoparticles of Various Sizes”, J. Phys. Chem. Bull., Vol. 105, 11424 to 11431 (2001)). According to the method, SWNT can be synthesized, but the processes of preparing a protein solution and occluding iron are involved therein, and therefore the method is so complicated that it is unsuitable for industrialization.

Wan et al. employ a method in which a thin film (thickness: 1 to 15 nm) of nickel is formed on a silicon substrate by molecular beam vapor deposition and in which the nickel film is molten by heating to form drop-like nickel particles (J. Wan et al., “Carbon nanotubes grown by gas source molecular beam epitaxy”, J. Crystal Growth, Vol. 227 to 228, p. 820 to 824 (2001)). In the process, catalyst metal particles grow to the order of several ten to several hundred nanometer due to an interaction between a silicon surface and nickel under a high temperature condition of CVD regardless of an initial film thickness of nickel, and it results in providing the problem that only a multiwalled carbon nanotube can be produced.

Nerushev et al. form a thin film (thickness: 0.5 to 20 nm) of iron on a silicon substrate by a sputtering method and heat it to thereby form drop-like iron fine particles (O. A. Nerushev et al., “The temperature dependence of Fe-catalysed growth of carbon nanotubes on silicon substrates”, Physica B., Vol. 323, p. 51 to 59 (2002)). The nanotube observed in the document is fundamentally a multiwalled nanotube, which shows that a diameter of the fine particles grows large. SWNT is produced as well in CVD at 900° C., but as can be observed from photographs in the document, nanotubes themselves are only sparsely present. In addition thereto, a large part of them is a thick multiwalled nanotube having a diameter of several ten nanometer, and that is anything but synthesis of only SWNT.

Yoon et al. form a thin film (thickness: 0.5 to 3 nm) of cobalt and molybdenum on a silicon substrate by a sputtering method and heat it to thereby form drop-like fine particles of a cobalt-molybdenum alloy (Y. J. Yoon et al., “Growth control of single and multi-walled carbon nanotubes by thin film catalyst”, Chem. Phys. Lett., Vol. 366, p. 109 to 114 (2002)). In the document, SWNT is successfully synthesized at 900° C. However, a sputtering device is necessary, and therefore the process is lacking in simplicity.

In Japanese Patent Application Laid-Open No. 189142/2001, in order to produce CNT, an oxide film on anode is formed on a substrate, and metal particles are supported thereon.

In Japanese Patent Application Laid-Open No. 255519/2002, in a method of supporting a metal catalyst on a porous body, a catalyst metal and a porous body are stirred in a solution and then dried by heat treatment.

In Japanese Patent Application Laid-Open No. 258582/2002, a layer holding metal fine particles is formed on a support by a composite plating method.

In Japanese Patent Application Laid-Open No. 285334/2002, fine particles of transition metal oxide are dispersed in ethanol, and a silicon substrate is dipped in the solution to form a thin film thereof on the silicon substrate.

In Japanese Patent Application Laid-Open No. 338221/2002, a thin film of metal (for example, aluminum) which is not a catalyst is formed on a ceramic substrate, and a metal catalyst is supported thereon.

In Japanese translation of PCT international application for patent application No. 500324/2003, after a photoresist layer is formed on a substrate, a part thereof is removed and the remaining part is oxidized to form a basis for growing CNT In U.S. Pat. No. 6,504,292, a metal catalyst is merely dispersed on a substrate.

The patents shown above have been applied, but conventional arts require vacuum deposition and sputtering devices in order to fix metal catalyst particles suited to SWNT on a solid surface of a silicon substrate and the like, and not only they are lacking in simplicity, but also it is very difficult to produce the desired state of fine particles even by using them. This is an essential problem originating in an interaction between a silicon substrate surface and metal, that is, a wetting property.

An object of the present invention is to uniformly and surely fix metal catalyst fine particles suited for producing SWNT on a solid surface of a substrate by a simple method.

### DISCLOSURE OF THE INVENTION

In the present invention, an interaction between a substrate surface and metal is improved to fix metal fine particles on a substrate.

A solution is prepared by dispersing or dissolving a catalyst metal salt of an inorganic compound or an organic compound in a solvent, and the solution is coated on the substrate described above. After drying the substrate, it is heated in an oxidative atmosphere to thereby remove the component of the solvent remaining on the substrate by oxidative decomposition to form fine particles of metal oxide on the substrate. Then, the oxidized metal fine particles are reduced in an atmosphere of an inert gas or a gas having reducing action to fix the metal fine particles on the substrate.

In the process of the present invention, the solution prepared by dispersing or dissolving the catalyst metal salt of the inorganic compound or the organic compound in the solvent is coated on the substrate, and therefore a thin coating film of a molecular level is formed on the surface of the substrate. Accordingly, a diameter of the catalyst metal fine particles fixed on the substrate after the operations of oxidizing and reducing the metal salt can be controlled to the order of nanometer.

### BRIEF DESCRIPTIONS OF THE DRAWINGS

FIG. 1 is a transmission electron micrograph of the catalyst metal fine particles produced by the process of the present invention.

FIG. 2 is a schematic diagram of a production apparatus for SWNT used in the examples.

FIG. 3 is a scanning electron micrograph of SWNT produced in Example 1.

FIG. 4 is a scanning electron micrograph of SWNT produced in Example 1.

FIG. 5 is a scanning electron micrograph of SWNT produced in Example 1.

FIG. 6 is a Raman spectroscopic spectral chart of SWNT produced in Example 1.

FIG. 7 is a scanning electron micrograph of SWNT produced in Example 2.

FIG. 8 is a scanning electron micrograph of SWNT produced in Example 2.

FIG. 9 is a scanning electron micrograph of SWNT produced in Example 2.

FIG. 10 is a Raman spectroscopic spectral chart of SWNT produced in Example 2.

FIG. 11 is a scanning electron micrograph of SWNT produced without allowing a surrounding gas to flow in a CCVD process after forming an Mo/Co catalyst on a silicon substrate in Example 3.

FIG. 12 is a scanning electron micrograph of SWNT produced without allowing a surrounding gas to flow in a CCVD process after forming an Mo/Co catalyst on a silicon substrate in Example 3.

FIG. 13 is a scanning electron micrograph of SWNT produced without allowing a surrounding gas to flow in a CCVD process after forming an Mo/Co catalyst on a silicon substrate in Example 3.

FIG. 14 is a Raman spectroscopic spectral chart of SWNT produced without allowing a surrounding gas to flow in a CCVD process after forming an Mo/Co catalyst on a silicon substrate in Example 3.

FIG. 15 is a scanning electron micrograph of SWNT produced while allowing argon/hydrogen to flow as a surrounding gas in a CCVD process after forming an Mo/Co catalyst on a silicon substrate in Example 3.

FIG. 16 is a scanning electron micrograph of SWNT produced while allowing argon/hydrogen to flow as a surrounding gas in a CCVD process after forming an Mo/Co catalyst on a silicon substrate in Example 3.

FIG. 17 is a scanning electron micrograph of SWNT produced while allowing argon/hydrogen to flow as a surrounding gas in a CCVD process after forming an Mo/Co catalyst on a silicon substrate in Example 3.

FIG. 18 is a Raman spectroscopic spectral chart of SWNT produced while allowing argon/hydrogen to flow as a surrounding gas in a CCVD process after forming an Mo/Co catalyst on a silicon substrate in Example 3.

FIG. 19 is a Raman spectroscopic spectral chart of SWNT produced while allowing argon/hydrogen to flow as a surrounding gas in a CCVD process after forming an Fe/Co catalyst on a quartz substrate in Example 3.

### BEST MODE FOR CARRYING OUT THE INVENTION

The substrate for supporting a metal which is the catalyst in the present invention shall not specifically be restricted as long as it can withstand a temperature in a CCVD process, and capable of being used are ceramics, inorganic non-metals, inorganic non-metal compound solids, metals and metal oxides, to be specific, for example, quartz plates, silicon wafers, crystal plates, fused silica plates and sapphire plates.

When forming a thin film on a substrate and then forming catalyst metal fine particles thereon, the thin film is a thin film of a metal oxide or a thin film of a porous substance, and it is, for example, a thin film of silica, alumina, titania, magnesia or the like or a thin film of a silica porous body, zeolite, mesoporous silica or the like.

The above thin films can be fixed by publicly known conventional methods, and a method described in Advanced Materials, Vol. 10, p. 1380 to 1385 (1998) can be applied.

A method for forming a thin film from a porous substance and a mesoporous substance includes a method in which gels of the above substances are merely coated and methods described in Japanese Patent Application Laid-Open No. 185275/1995 (zeolite film) and Japanese Patent Application Laid-Open No. 233995/2000 (mesoporous body).

Next, the metal which is the catalyst is a transition metal belonging to the fifth A group, the sixth A group and the eighth group in the periodic table of elements and includes, for example, Fe, Co, Mo, Ni, Rh, Pd and Pt, and among them, Fe, Co and Mo are preferred. These metals may be used alone or in a mixture of two or more kinds thereof.

In fixing the catalyst metal on a substrate having a smooth solid surface or a substrate having a thin film of a metal oxide on a surface thereof, a solution prepared by dispersing or dissolving an organic or inorganic metal compound in water, an organic solvent or a mixed solvent thereof is coated on a substrate on which a thin film of a metal oxide is formed by dip coating or spin coating. In the case of dip coating, the substrate is dipped in the above solution for 10 seconds to 60 minutes, and then it is pulled up at a fixed speed or the solution is drawn out from the bottom of the vessel. In the case of spin coating, operation is carried out so that the solution is evenly dispersed on the whole surface while rotating the substrate.

When fixing the catalyst metal on the substrate on which a thin film of a porous body is formed, the substrate is dipped in the solution described above while evacuating the substrate to impregnate the pores with the solution (vacuum impregnation), and after taking out the substrate from the solution, the surface thereof is washed with an organic solvent.

The metal salt of the organic compound which is the raw material for the catalyst metal includes, for example, acetates, oxalates and citrates. The metal salt of the inorganic compound which is the raw material for the catalyst metal includes, for example, nitrates or oxoacid salts of the above metals (for example, ammonium molybdate). These metal compounds may be used alone or in a mixture of two or more kinds thereof.

It is preferred for forming a thinner coating film of a metal salt on the surface of the substrate that the metal salt is used as the raw material for the metal fine particles in such a concentration that a weight concentration of the catalyst metal contained in the metal salt is 0.0005 to 0.5% by weight based on the total amount of the solution.

The solvent for dispersing or dissolving the metal salt such as water, an organic solvent and a mixture thereof shall not specifically be restricted as long as it can disperse or dissolve the metal compound. Capable of being preferably used as the organic solvent are alcohols such as methanol, ethanol and propanol, aldehydes such as acetaldehyde and formaldehyde and ketones such as acetone and methyl ethyl ketone, and it may be a mixture thereof. Further, water of up to 5% by weight may be mixed therein. Also, an aqueous solution prepared by dissolving a carboxylic acid or a carboxylate in water can be used.

Further, 0.1 to 10% by weight of nonionic surfactants or polyhydric alcohols may be added as a binder to the solution. Any compounds may be used as long as they are nonionic surfactants or polyhydric alcohols. The nonionic surfactants are preferably ethers of alcohols containing an ethoxy group, and an alkyl alcohol ethoxylate is particularly preferred. The polyhydric alcohols are preferably glycerin and ethylene glycol.

The solution or the dispersion of the metal compound is coated on the substrate and then heated at 300° C. or higher, preferably 350° C. or higher in an oxidative atmosphere, whereby the organic component such as the remaining solvent and the organic acid component is oxidized and decomposed, and the metal oxide fine particles are fixed on the thin film described above.

Then, the metal oxide is heated at 500° C. or higher in a reducing atmosphere such as gas flow containing an inert gas and hydrogen, and the oxide is reduced to turn into metal. The oxide fine particles are strongly adhered on the substrate via a thin film of silica and the like, and therefore the reduced metal fine particles are uniformly fixed on the substrate without causing unevenness.

The above metal which is the catalyst can readily be oxidized and reduced by heating in an electric furnace while allowing the respective surrounding gases to flow. The metal fine particles fixed have a particle diameter of about 0.5 to 10 nm and are suited to a catalyst for producing SWNT.

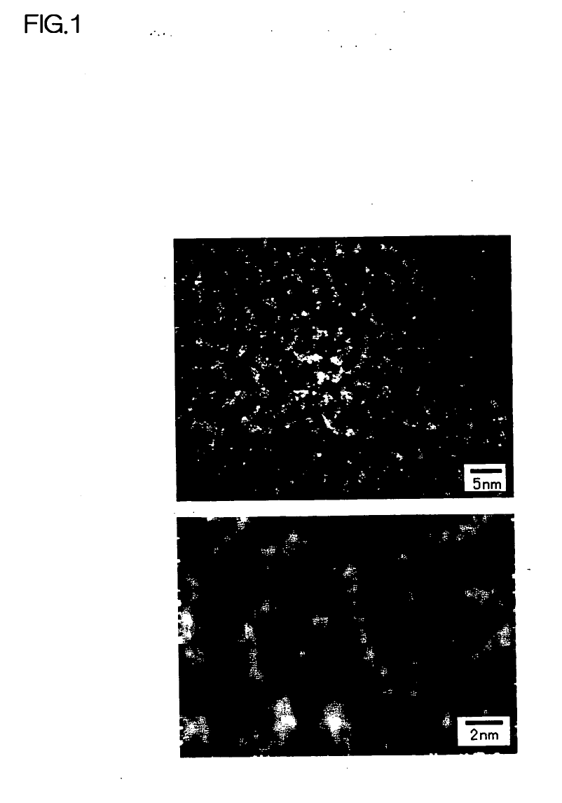

Actually, a transmission electron micrograph of catalyst metal fine particles formed on a substrate is shown in FIG. 1. In this case, fine particles of Mo/Co are formed on a quartz substrate. In FIG. 1, a part in which the catalyst metal fine particles are formed is shown in the form of a black image. It has been confirmed by X-ray photoelectron spectroscopy that Mo and Co are fixed on the surface of the substrate. As can be found from this chart, the catalyst metal fine particles formed on the substrate by the process of the present invention are uniformly formed in a diameter of 2 nm or less on the whole surface of the substrate.

The above metal fine particle catalyst is used to produce a single-walled carbon nanotube at a reaction temperature of 500 to 900° C., whereby the single-walled carbon nanotube in which a distribution of a diameter is narrow and in which a diameter is uniform can be formed on the substrate.

### EXAMPLES

The present invention shall be explained below in further details with reference to examples, but the present invention shall not be restricted to the examples described below.

### Example 1

### Formation of Catalyst Metal Fine Particles on a Substrate Having a Thin Film of Metal Oxide on a Surface)

1. Preparation of Silica Film

A method for preparing a silica film was referred to Advanced Materials, Vol. 10, p. 1380 to 1385 (1998).

A silicon wafer was used for a substrate. A mixed solution of tetraethyl orthosilicate (TEOS): ethanol water:hydrochloric acid=1:40:9.2:0.02 (mole ratio) was coated on the substrate by dipping and dried to form a silica film on the substrate.

2. Fixing of Catalyst Metal Fine Particles

An iron acetate and cobalt acetate mixed solution (metal weight ratio=0.01 wt %, Fe/Co=1) was prepared using ethanol as a solvent, and the silicon substrate having a silica film prepared in (1) described above was dipped therein in the atmosphere for 10 minutes. Then, the substrate was pulled up from the solution at a constant speed by means of a self-composed pulling-up machine (comprising a clip, a motor, a string and a pulley). The substrate was spontaneously dried and then heated at about 400° C. in the air, whereby the acetic acid component and the organic component which were stuck on the substrate surface were removed by oxidative decomposition to form fine particles of the metal oxide on the substrate.

3. Preparation of Metal Fine Particle Catalyst and Production Experiment of SWNT by CCVD

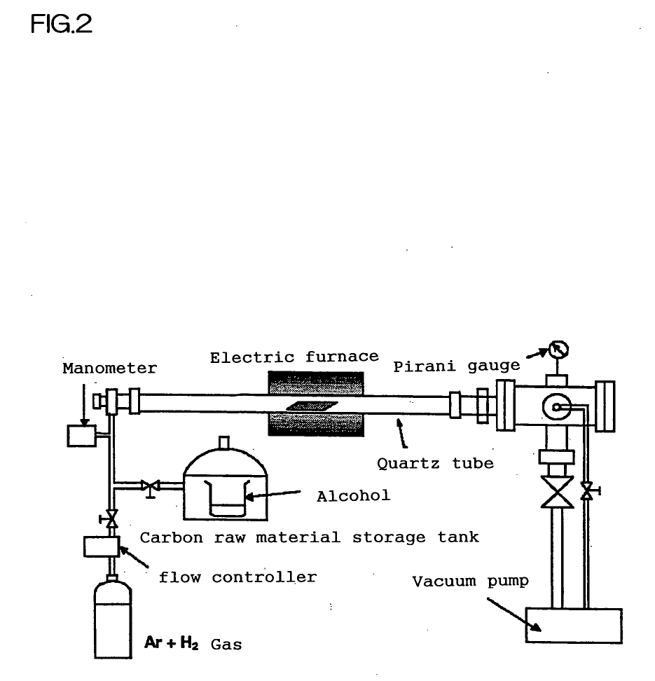

A schematic diagram of a CCVD apparatus used in the present invention is shown in FIG. 2.

The substrate on which the metal oxide fine particles were fixed was put in the middle of a quartz glass tube having a diameter of about one inch, and this part (hereinafter referred to as the heating part) was heated by means of an electric furnace. The heating part was heated in an argon/hydrogen mixed gas atmosphere, and supply of the argon/hydrogen mixed gas was stopped after the heating part reached 750° C. The metal oxide fine particles were reduced to turn into the metal fine particles of a catalyst.

Subsequently, ethanol vapor was fed as a raw material for SWNT to the heating part, and after fixed time passed, ethanol vapor flow was stopped. Then, heating by the electric furnace was stopped, and the temperature was lowered again down to room temperature in the argon/hydrogen mixed gas atmosphere.

4. Experimental Result

The results of the CCVD experiment carried out according to the procedures 1 to 3 described above shall be shown.

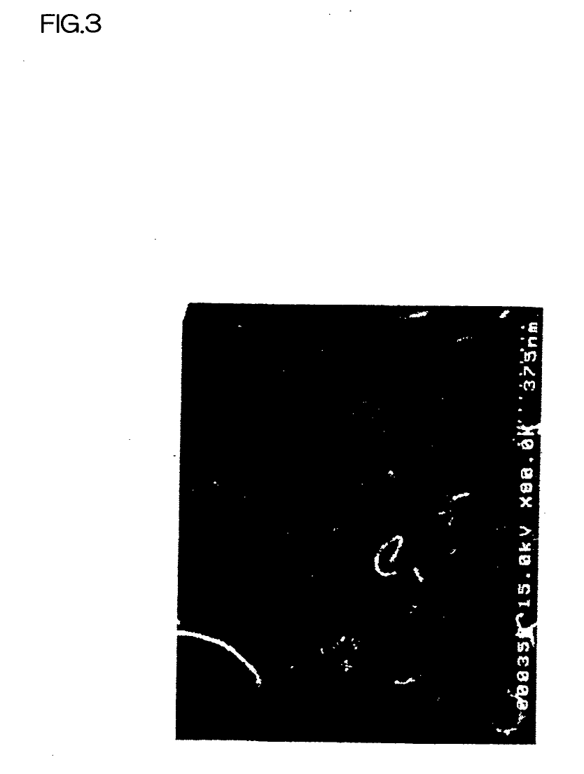

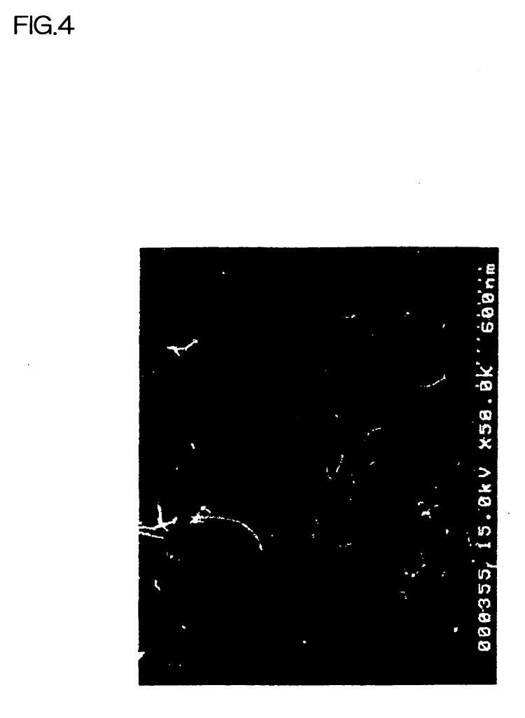

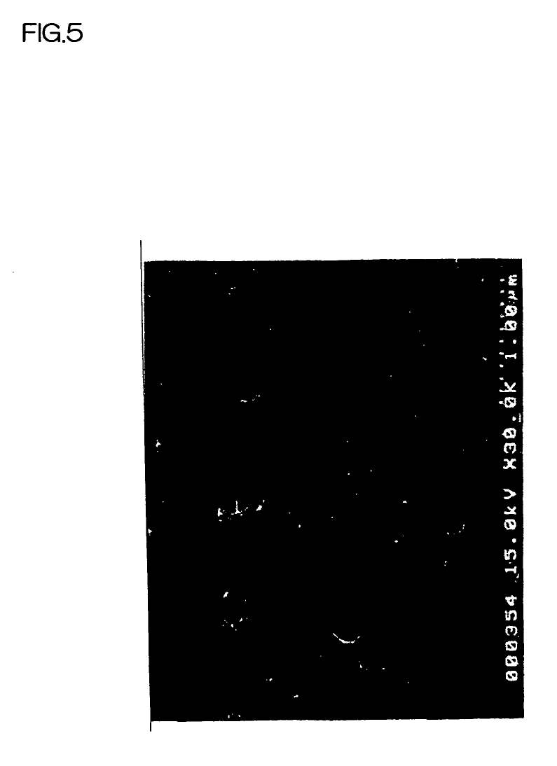

The scanning electron micrographs (SEM) of SWNT obtained are shown in FIG. 3 to FIG. 5. The above three photographs were taken at different magnifications (the magnification and the scale are shown in a left lower part of the photograph) for the same portion, and a string-like substance which is photographed white is SWNT. Enlargement of any parts on the silicon substrate shows that SWNT produced is in the same state as the above, and it can be found that a large amount of SWNT is produced evenly on the silica thin film.

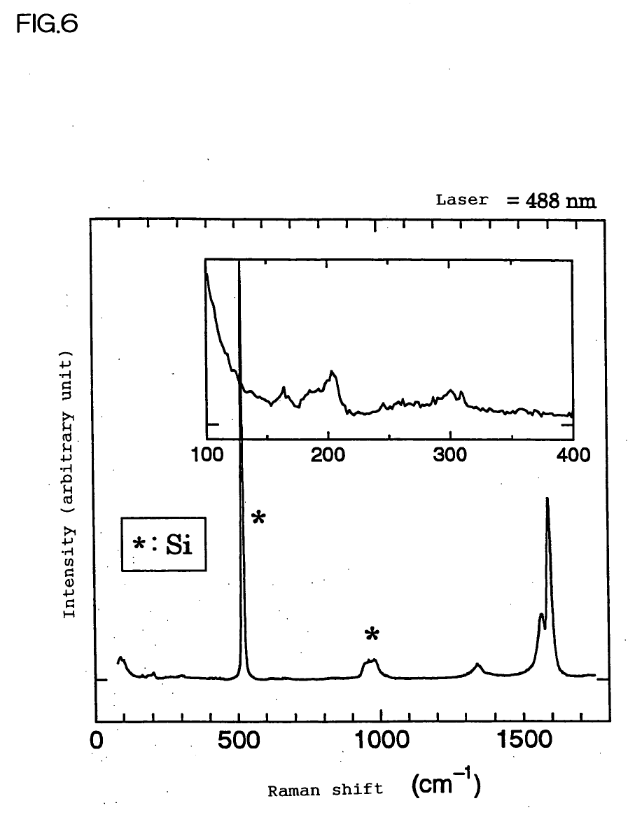

It was confirmed by Raman spectroscopic spectra of this sample shown in FIG. 6 that they were SWNT.

### Example 2

### Formation of Catalyst Metal Fine Particles on a Substrate Having a Thin Film of a Porous Body on a Surface

1. Preparation of a Substrate Having a Mesoporous Silica Thin Film

A silicon wafer was used for a substrate. A mesoporous silica film was produced on this substrate according to a procedure and a mixing ratio of a solution shown in Japanese Patent Application Laid-Open No. 233995/2000.

2. Fixing of Catalyst Metal Fine Particles

An iron acetate and cobalt acetate mixed solution (metal weight ratio=0.01 wt %, Fe/Co=1) was prepared using ethanol as a solvent, and the silicon substrate having a mesoporous silica film prepared in (1) described above was dipped in the solution to impregnate a mesoporous silica structure with a catalyst metal salt for one hour in a desiccator while evacuating. The substrate was taken out into the atmosphere and lightly washed a surface thereof with ethanol, and then it was heated to about 400° C. in the air, whereby fine particles of the metal oxide were formed on the substrate.

3. Preparation of Metal Fine Particle Catalyst and Production Experiment of SWNT by CCVD

The substrate produced above on which the metal oxide fine particles were fixed was used to produce SWNT in the same manner as in Example 1.

4. Experimental Result

SWNT was produced on the mesoporous silica thin film as was the case with Example 1.

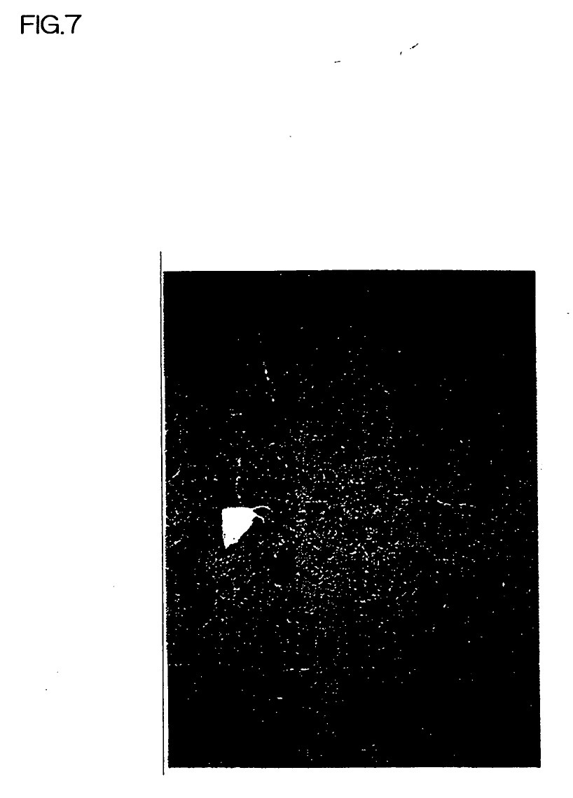

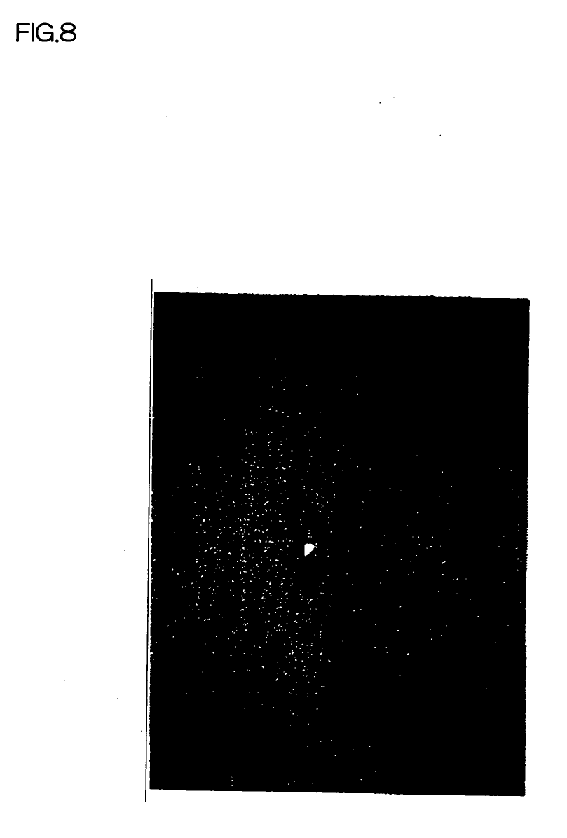

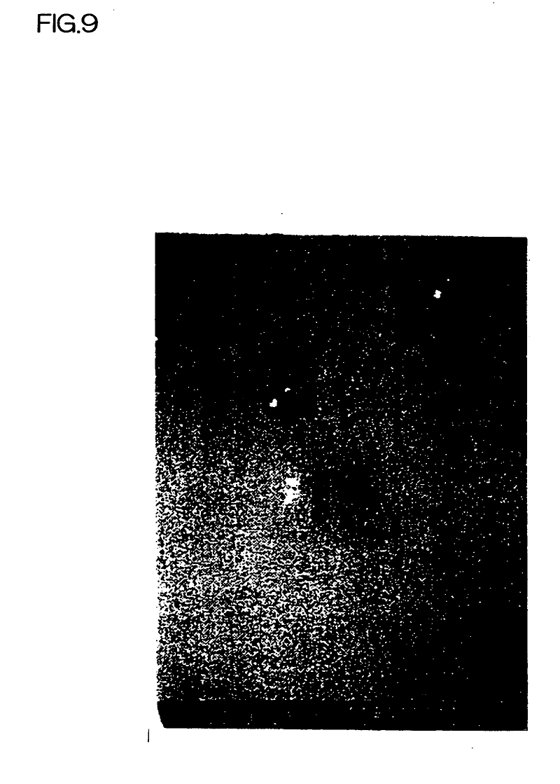

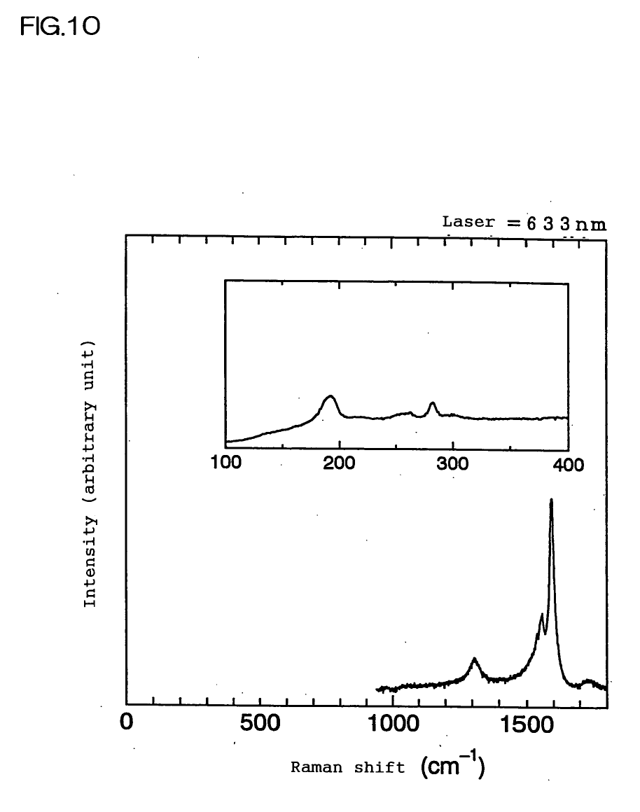

The scanning electron micrographs (SEM) of SWNT obtained are shown in FIG. 7 to FIG. 9. It was confirmed by Raman spectroscopic spectra of this sample shown in FIG. 10 that they were SWNT.

### Example 3

### Formation of Catalyst Metal Fine Particles on a Substrate Having a Smooth Solid Surface

1. Preparation of a Catalyst Metal Salt Solution

Powders of molybdenum acetate and cobalt acetate were dissolved in ethanol weighed in a beaker so that a metal weight contained in each metal salt was 0.01% by weight based on the total amount of the solution. Further, ethylene glycol was added thereto in a proportion of 1% by weight based on the total amount of the solution, and the solution was subjected to supersonic dispersion to prepare a catalyst metal salt solution.

The combination of molybdenum and cobalt or iron and cobalt was used as the kind of the catalyst metals.

2. Coating of the Catalyst Metal Salt Solution on a Substrate

2-1 Case of Dip Coating

A silicon substrate or a quartz substrate each having a clean surface was dipped in the catalyst metal salt solution prepared in (1) described above for 30 minutes. After 30 minutes passed, the substrate was pulled up at a constant speed of 4 cm/minute.

2-2 Case of Spin Coating

A silicon substrate or a quartz substrate each having a clean surface was set to a spin coater, and one ml of the catalyst metal salt solution prepared in (1) described above was dropped thereon through a pipet while rotating the substrate at a constant speed. After the solution was sufficiently spread, rotation of the spin coater was stopped, and the substrate was taken out.

In both cases, a wafer (product number: SI-500452, n type, (100) face) manufactured by Nilaco Corporation was used as the silicon substrate.

3. Oxidative Decomposition of Substances Remaining on the Surface

The substrate was put in an electrical furnace (aerial atmosphere) heated at 400° C. within one minute after finishing the process of (2) described above, and it was held therein for about 5 minutes. Organic components such as an organic solution adsorbed on the surface were oxidized and removed by this step, and fine particles of an oxide of the catalyst metal were formed on the surface of the substrate.

4. Preparation of Metal Fine Particle Catalyst and Production of SWNT by CCVD

The substrate produced above on which the metal oxide fine particles were fixed was used to subject to heat treatment in the same manner as in Example 1 to thereby form catalyst metal fine particles thereon, and then SWNT was produced.

5. Experimental Result

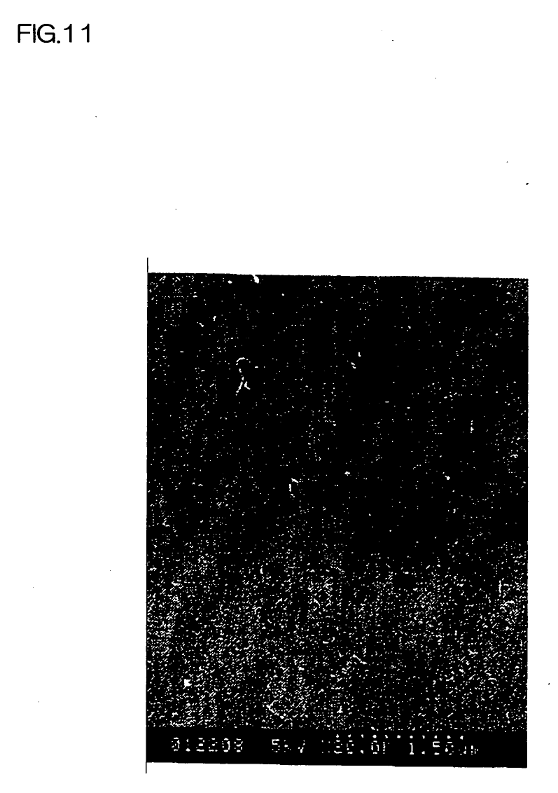

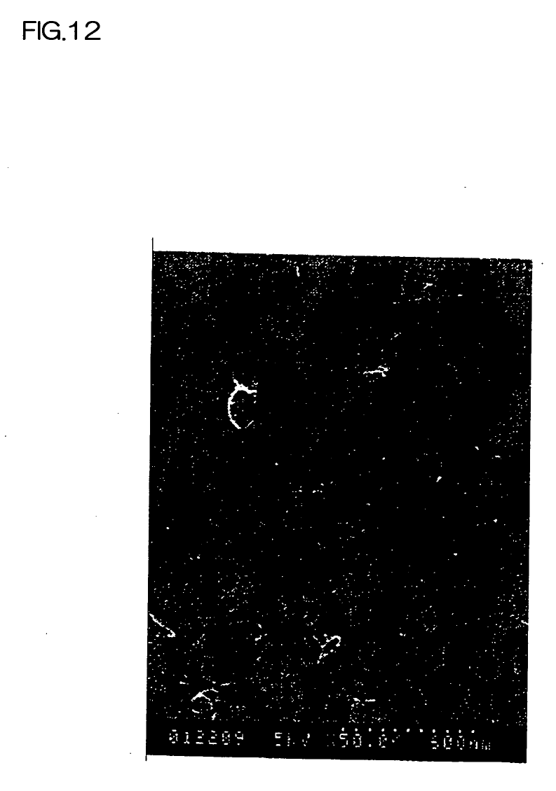

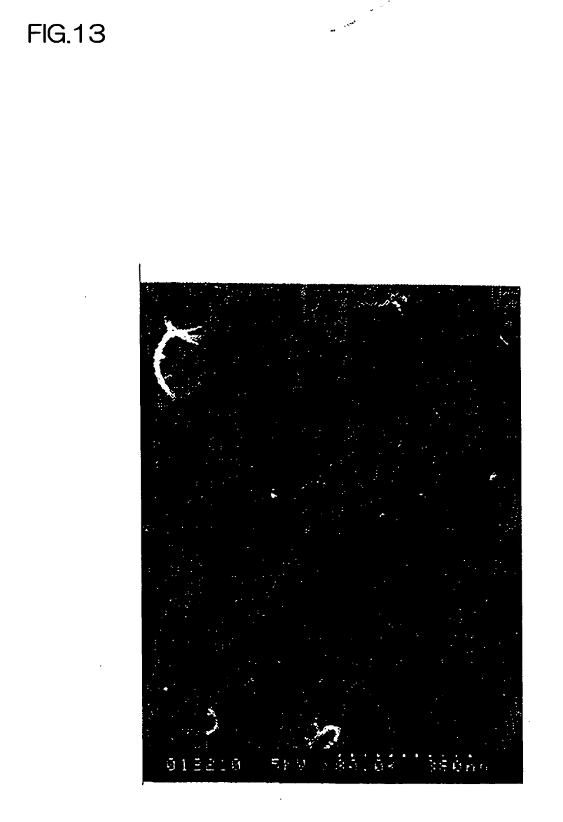

Shown in FIG. 11 to 13 are the scanning electron micrographs (SEM) of SWNT synthesized directly on the silicon substrate when nothing was allowed to flow at the time of elevating the temperature in the CCVD process. A mixture of molybdenum and cobalt is used for the catalyst metal. In the photographs, the same portion is photographed changing the magnification. A line looking white is SWNT or a bundle thereof, and it looks thicker than actual because of charging. A dark grey part observed in the background is a silicon substrate surface. The magnification and the reduced scale are shown by a black band in a lower part of the photographs.

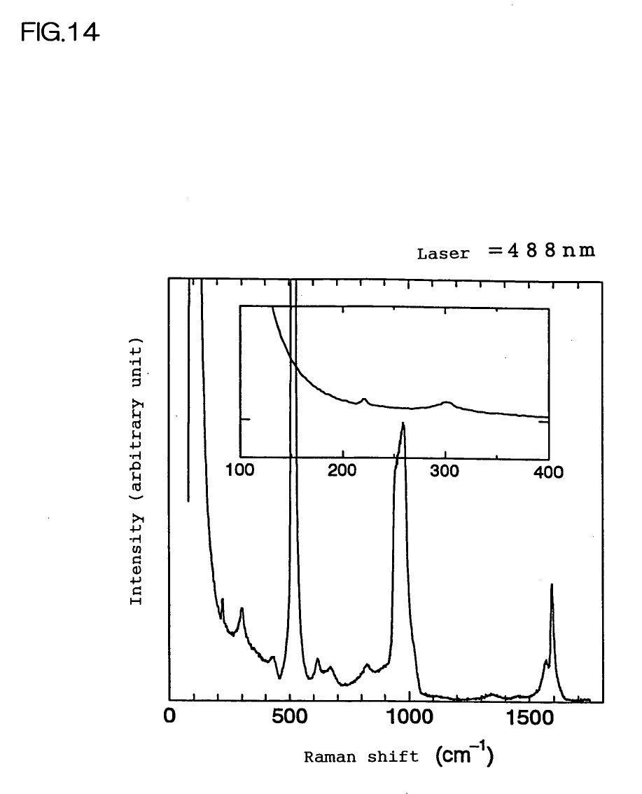

Shown in FIG. 14 is a result of Raman analysis of the sample of the SEM photographs shown in FIG. 11 to 13 described above. A laser used is 488 nm, and a ratio of an intensity of a G-band in the vicinity of 1590 cm⁻¹ to an intensity of a D-band in the vicinity of 1350 cm⁻¹, a so-called G/D ratio reaches 30. This shows that SWNT synthesized on the silicon substrate has a very good quality. Further, the G-band is split into two peaks, and it is, together with the SEM photographs, evidence for the fact that what is synthesized there is SWNT (this judgment is supported by a document: Jorio et al., Phys. Rev. Lett., Vol. 186, p. 1118 (2001)). In the figure, a figure inserted in the upper part is an enlarged figure of a low wave number region. Peaks observed in the vicinity of 226 cm⁻¹ and 303 cm⁻¹ are peaks originating in silicon, and a peak originating in a radial breathing mode (RBM) of SWNT can not be measured since it is buried in silicon noise. Peaks including peaks in the vicinity of 521 cm⁻¹ and 963 cm⁻¹ also are peaks originating in silicon, and a peak of 100 cm⁻¹ is Rayleigh's noise in a measuring system.

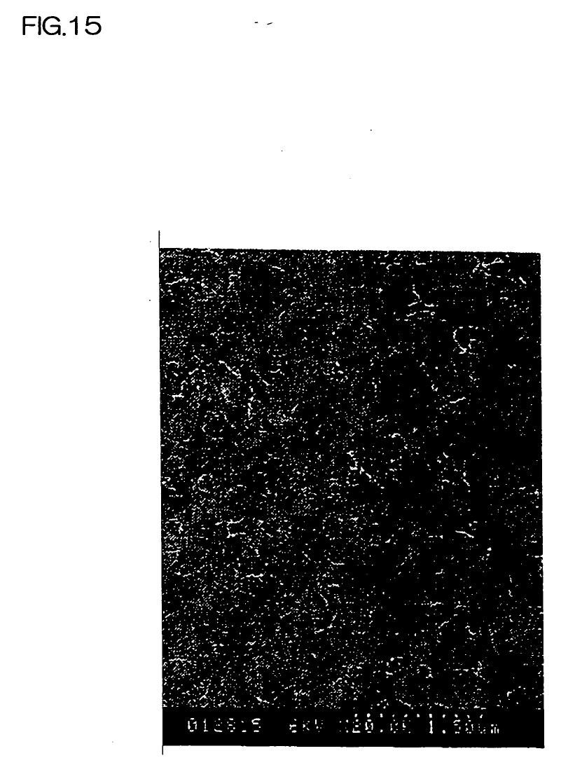

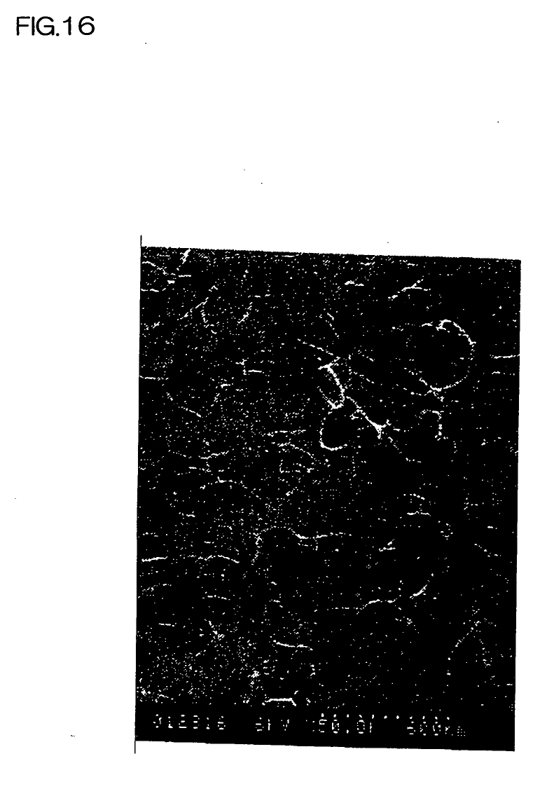

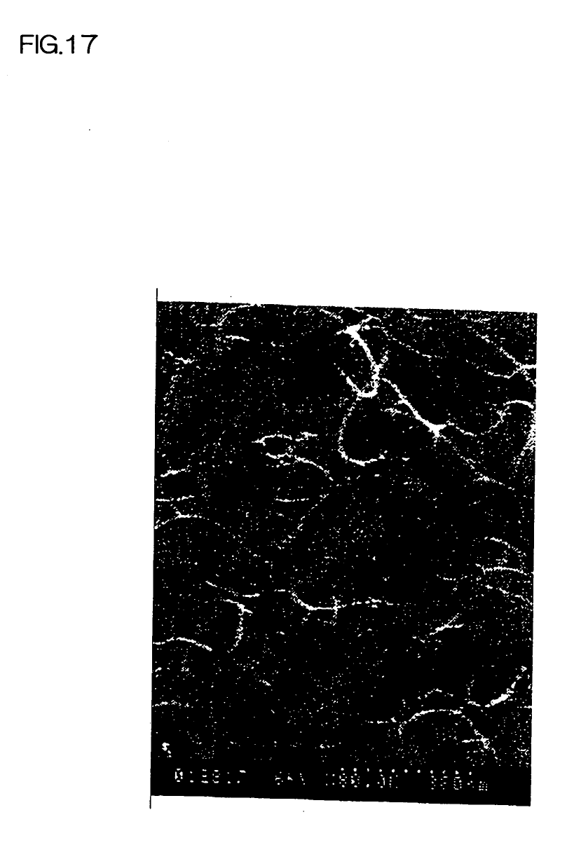

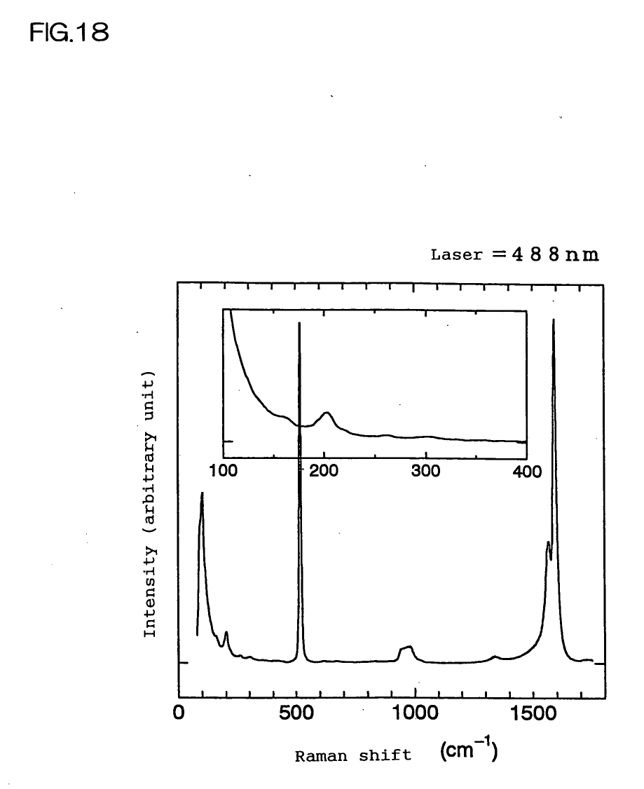

Shown in FIG. 15 to 17 are the scanning electron micrographs (SEM) of SWNT synthesized directly on the silicon substrate when a mixed gas of argon and hydrogen was allowed to flow at the time of elevating the temperature in CCVD. A mixture of molybdenum and cobalt is used for the catalyst metal, and the same portion is photographed changing the magnification. Lines looking white are SWNT and a bundle thereof. A very large amount of SWNT is synthesized, and therefore an silicon surface can not be observed (a color of the silicon surface on the SEM photograph is, as observed in FIG. 11 to 13, more gloomy). What looks shining white is a SWNT bundle which protrudes in the air and shines with charging, and it is considered that all of light grey parts in the background are SWNT adhering tightly to a silicon surface. This interpretation is supported by a result of Raman spectroscopy shown in FIG. 18.

Shown in FIG. 18 is a result of Raman analysis which is evidence for interpretation of the SEM photographs shown in FIG. 15 to 17. A laser used is 488 nm. Comparing with the case of FIG. 14 with a silicon noise intensity appearing in the vicinity of 963 cm⁻¹ setting as a standard, it can be found that a Raman intensity of SWNT is markedly elevated. This supports that a very large amount of SWNT is synthesized on the silicon substrate. The G/D ratio exceeds 50, and this shows that SWNT synthesized on the silicon substrate has a very good quality and contains almost no impurities such as amorphous carbon and MWNT. A peak present in the vicinity of 203 cm⁻¹ is called a radial breathing mode (RBM), and this peak shows such an intensity that a silicon peak present in the vicinity of 303 cm⁻¹ is buried, which further supports that what is synthesized by this experiment is SWNT. Peaks present in the vicinity of 521 cm⁻¹ and 963 cm⁻¹ are peaks originating in silicon, and a peak of 100 cm⁻¹ is noise in a measuring system.

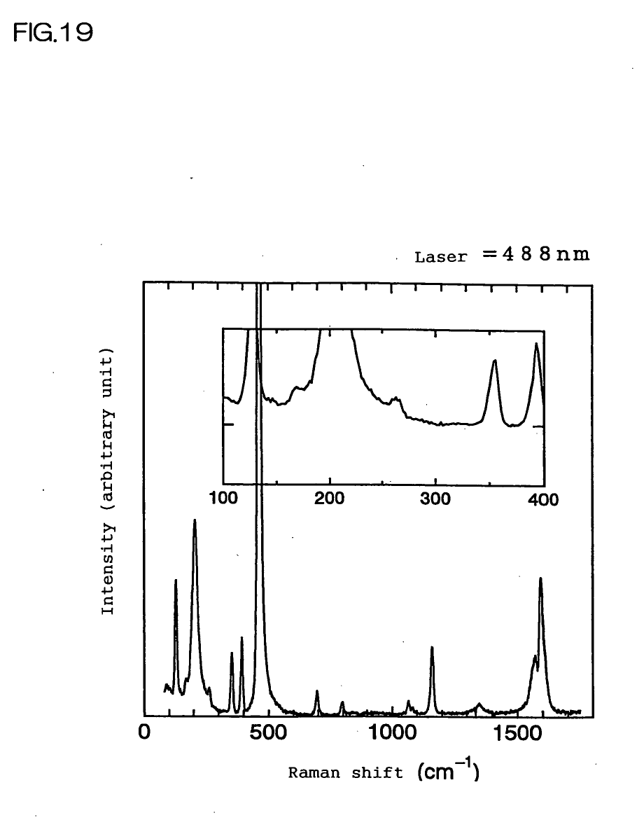

Shown in FIG. 19 is a Raman waveform on a smooth quartz substrate when using a mixture of iron and cobalt for the catalyst and allowing a mixed gas of argon and hydrogen to flow at the time of elevating the temperature in the CCVD process. A laser used is 488 nm. A G-band in the vicinity of 1590 cm⁻¹ is split, and it is shown that SWNT is produced. The G/D ratio exceeds 10, and it is shown that SWNT has a sufficiently high quality. In the figure, a peak in the vicinity of 260 cm⁻¹ shown in an inserted figure in an upper part is a radial breathing mode (RBM), and this supports that it is possible to synthesize SWNT as well directly on the smooth quartz substrate. The other peaks are peaks originating in quartz or noise in an incident laser.

### INDUSTRIAL APPLICABILITY

According to the present invention, metal catalyst fine particles suited for producing SWNT can uniformly and surely be fixed on a substrate, and SWNT can be produced at a high purity by a CCVD process.

1. A process for forming catalyst metal fine particles for synthesizing a carbon nanotube by a thermal decomposition method on a substrate, comprising:
a step of coating a solution prepared by dispersing or dissolving a catalyst metal salt of an inorganic compound or an organic compound in a solvent on the substrate,
a step of drying the substrate coated with the solution,
a step of heating the substrate in an oxidative atmosphere to thereby remove the component of the solvent described above remaining on the substrate by oxidative decomposition and forming fine particles of an oxide of the catalyst metal on the substrate and
a step of reducing the fine particles of the oxide of the catalyst metal by heating in an atmosphere of an inert gas or a gas having reducing action to fix the fine particles of the catalyst metal on the substrate.

2. The process for forming catalyst metal fine particles as described in claim 1, wherein the substrate has a smooth solid surface.

3. The process for forming catalyst metal fine particles as described in claim 1, wherein the substrate has a thin film comprising a metal oxide on a surface thereof, and the catalyst metal fine particles are formed on the thin film.

4. The process for forming catalyst metal fine particles as described in claim 3, wherein the metal oxide comprises silica, alumina, titania or magnesia.

5. The process for forming catalyst metal fine particles as described in claim 1, wherein the solution is coated on the substrate by dip coating or spin coating.

6. A process for forming catalyst metal fine particles for synthesizing a carbon nanotube by a thermal decomposition method on a substrate having a thin film of a porous body on a surface thereof, comprising:
a step of impregnating pores of the thin film formed on the substrate with a solution prepared by dispersing or dissolving a catalyst metal salt of an inorganic compound or an organic compound in a solvent by vacuum impregnation,
a step of washing the surface of the substrate,
a step of heating the substrate in an oxidative atmosphere to thereby remove the solvent remaining on the substrate by oxidative decomposition and forming fine particles of an oxide of the catalyst metal on the substrate and
a step of reducing the fine particles of the oxide of the catalyst metal by heating in an atmosphere of an inert gas or a gas having reducing action to fix the fine particles of the catalyst metal on the substrate.

7. The process for forming catalyst metal fine particles as described in claim 6, wherein the porous body comprises zeolite or mesoporous silica.

8. The process for forming catalyst metal fine particles as described in claim 1, wherein the salt of the organic compound of the catalyst metal is acetate, citrate or oxalate.

9. The process for forming catalyst metal fine particles as described in claim 1, wherein the salt of the inorganic compound of the catalyst metal described above is nitrate or an oxo-acid salt of the metal.

10. The process for forming catalyst metal fine particles as described in claim 1, wherein the substrate comprises ceramics, silicon, quartz, crystal or glass.

11. The process for forming catalyst metal fine particles as described in claim 1, wherein the catalyst metal contained in the catalyst metal salt of the organic compound or the catalyst metal salt of the inorganic compound in the solution has a weight concentration of 0.0005 to 0.5% by weight.

12. The process for forming catalyst metal fine particles as described in claim 1, wherein the solvent is an organic solvent or an aqueous solution.

13. The process for forming catalyst metal fine particles as described in claim 12, wherein the organic solvent is any of alcohols, aldehydes or ketones.

14. The process for forming catalyst metal fine particles as described in claim 13, wherein the alcohol is methanol, ethanol or propanol.

15. The process for forming catalyst metal fine particles as described in claim 12, wherein the aqueous solution is prepared by dissolving a carboxylic acid or a carboxylate in water.

16. The process for forming catalyst metal fine particles as described in claim 1, wherein a nonionic surfactant or a polyhydric alcohol is added to the solution.

17. The process for forming catalyst metal fine particles as described in claim 16, wherein the nonionic surfactant or the polyhydric alcohol has a weight concentration of 0.1 to 10% by weight based on the solution.

18. The process for forming catalyst metal fine particles as described in claim 16, wherein the nonionic surfactant is ethers of alcohols having an ethoxy group.

19. The process for forming catalyst metal fine particles as described in claim 18, wherein the ether is an alkyl alcohol ethoxylate.

20. The process for forming catalyst metal fine particles as described in claim 16, wherein the polyhydric alcohol is glycerin or ethylene glycol.

21. The process for forming catalyst metal fine particles as described in claim 1, wherein the catalyst metal is a transition metal belonging to the fifth A group, the sixth A group and the eighth group in the periodic table of elements.

22. The process for forming catalyst metal fine particles as described claim 21, wherein the transition metal is any simple substance of Fe, Co, Mo, Ni, Rh, Pd and Pt or a mixture of two or more kinds thereof.

23. The process for forming catalyst metal fine particles as described in claim 1, wherein the substrate is heated at a temperature of 300° C. or higher in an oxidative atmosphere.

24. The process for forming catalyst metal fine particles as described in claim 23, wherein the substrate is heated at a temperature of 350° C. or higher in an oxidative atmosphere.

25. The process for forming catalyst metal fine particles as described in claim 1, wherein the oxide of the catalyst metal is reduced at a temperature of 500° C. or higher.

26. A process for synthesizing a single-walled carbon nanotube at a synthetic temperature of 500 to 900° C. using a substrate on which catalyst metal fine particles are formed by the process for forming catalyst metal fine particles as described in claim 1.
